(19) United States
(12) Patent Application Publication
(10) Pub. No.: US 2004/0208195 A1
(43) Pub. Date: Oct. 21, 2004

(54) Apparatus and method for connecting separate networks

(75) Inventors: Do-heon Kim, Seoul (KR); Hyun-gyoo Yook, Seoul (KR); Hyun-sik Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/816,887

(22) Filed: Apr. 5, 2004

(30) Foreign Application Priority Data
Apr. 16, 2003 (KR) 10-2003-0024173

(51) Int. Cl. H04L 12/66

(52) U.S. Cl. 370/463

(57) ABSTRACT

The present invention relates to an apparatus and method for connecting separate networks. The network connection apparatus of the present invention includes a join module for connecting a network, to which the join module belongs, with a first network in response to an inter-network connection request message transmitted from the first network, setting a security level of the connected first network, and controlling a network command message in response to the set security level. According to the present invention, there is an advantage in that mutual connection and control between devices present in the separate networks can be made by connecting the separate networks with one another.

### BACKGROUND OF THE INVENTION

This application claims the priority of Korean Patent Application No. 10-2003-0024173 filed on Apr. 16, 2003, in the Korean Intellectual Property Office, the disclosure of which is incorporated herein by reference.

1. Field of the Invention

Apparatuses and methods consistent with the present invention relate to connecting separate networks, and more particularly, to connecting separate networks, wherein devices present in the network can be mutually controlled by connecting the separate networks with one another.

2. Description of the Prior Art

Generally, a home network is constructed of a private network based on Internet protocol (IP) and controls a variety of equipment, such as all types of personal computers, intelligent products and wireless apparatus used in the home, by connecting them in one network.

FIG. 1 is a diagram schematically showing a home network of the related art. The configuration of a UPnP (Universal Plug and Play) home network is roughly divided into a UPnP controlled device 20 (hereinafter, referred to “UPnP CD”) to be controlled and a UPnP control point 10 (hereinafter, referred to “UPnP CP”) for controlling the UPnp CD 20.

The UPnP CD 20 may include a plurality of UPnP devices each of which realizes a specific service according to its own function, and the UPnP CP 10 controls the UPnP CD 20 by analyzing an Extended Markup Language (XML) file in which the service of a specific device is described.

FIGS. 2a to 2d are diagrams showing an operation process for controlling UPnP controlled devices present in a home network of the related art. To control UPnP devices in a current UPnP home network, discovery and description processes are performed so that information on the UPnP CD 20 can be obtained. Thus, the UPnP CD 20 can be controlled through the information on the UPnP CD 20 connected to the home network, which is obtained through the foregoing processes. Here, the UPnP CP 10 searches for a device to be controlled by the UPnP CP 10 through the discovery process, analyzes what commands the UPnP CP 10 can give to a specific device by reading the service template XML of the UPnP device searched during the discovery process through the description process, and controls the UPnP device by sending a command in the form of a Simple Object Access Protocol (SOAP) message to a specific service of the UPnP device to be controlled by the UPnP CP 10 through a control process. In the meantime, the UPnP CD 20 performs an event process for transmitting changed information of its own to the UPnP CP 10.

FIG. 2a shows a discovery process. The discovery process can be roughly divided into two cases for the following explanations. One is a case where a new UPnP device is added to a home network, and the other is a case where a new UPnP CP 10 is added to a home network.

First, the case where a UPnP device (e.g., UPnP CD1) is added to a network is called advertising. In such a case, the UPnP device transmits a multicast message to a UPnP CP 10 to inform the UPnP CP 10 of its presence. That is, in a state where a UPnP CP 10 is present in a network, the UPnP device is added to the network and is then assigned a unique Uniform Resource Locator (URL) of its own through an addressing process. Thereafter, the UPnP device informs all the devices or the UPnP CP 10 present in the network of its presence by transmitting a multicast message to all the devices and/or the UPnP CP 10 present in the network. The UPnP CP 10 that intends to control the UPnP device receives the message multicast from the UPnP device and registers the UPnP device.

On the other hand, in a case where a UPnP CP 10 is newly added to a home network in a state where UPnP devices are present in the network, the UPnP CP 10 transmits a multicast message, and accordingly, the UPnP device transmits a unicast message to the UPnP CP 10 that is looking for UPnP devices. That is, if the UPnP devices receive a search message multicast from the UPnP CP 10 and then transmits a unicast response message to the UPnP CP 10 looking for UPnP devices in a state where the UPnP devices have completed the addressing process and have been assigned their own URL, the UPnP CP 10 which has received the response messages registers the UPnP devices.

FIG. 2b shows a description process. The description process means the process of obtaining service functions necessary for the UPnP CP 10 to control a UPnP device by analyzing the service description XML file provided from the UPnP device. That is, the UPnP CP 10 that intends to control a UPnP device requests the UPnP device for its description XML file, and parses the requested description XML file.

FIG. 2c shows a control process. The control process means a process in which the UPnP CP 10 transmits a command in the form of a SOAP message to a specific service of the UPnP device to be controlled by the UPnP CP 10 in a state where the UPnP device and the UPnP CP 10 mutually know their own URL addresses through the addressing and discovery processes. That is, the UPnP CP 10 can directly control the UPnP device by transmitting a service template for the UPnP device to be controlled by the UPnP CP 10.

FIG. 2d shows an event process. The event process means a process in which if the UPnP CP 10 requests a relevant UPnP CD 20 subscription so that the UPnP CP 10 can know about changes in the information status of the UPnP CD 20, the UPnP CD 20 transmits an event message informing the UPnP CP 10 whenever information on the UPnP device is changed.

However, since the home network technology of the related art can be employed in the home, it has spatial limitations. That is, device connections in the home are locally constructed, and thus, the UPnP operates only on a single home network. Therefore, there is a problem in that the UPnP itself cannot allow two or more separate home networks to be flexibly connected to one another.

### SUMMARY OF THE INVENTION

An aspect of the present invention is to solve the aforementioned problem. Accordingly, it is an aspect of the present invention to provide an apparatus and method for connecting separate networks, wherein devices present in the networks can be mutually controlled by connecting the separate networks with one another.

According to an aspect of the present invention for achieving the above, there is provided a network connection apparatus, comprising a join module for connecting a network, to which the join module belongs, with a first network in response to an inter-network connection request message transmitted from the first network, setting a security level of the connected first network, and controlling a network command message in response to the set security level.

According to another aspect of the present invention, there is provided a method for connecting separate networks, comprising the steps of (a) transmitting an initial inter-network connection request message to a second network by a first network; (b) analyzing the received initial inter-network connection request message and setting a security level of the first network by the second network; (c) transmitting a network command message to the second network by the first network; (d) searching, by the second network, the set security level of the first network which has transmitted the network command message; and (e) transmitting the searched security level and the received network command message to the second network.

### BRIEF DESCRIPTION OF THE DRAWINGS

The above and other aspects, features and advantages of the present invention will become apparent from the following description of an exemplary embodiment given in conjunction with the accompanying drawings, in which:

FIG. 1 is a diagram schematically showing a home network of the related art;

FIGS. 2a to 2d are diagrams showing an operation process for controlling UPnP controlled devices present in a home network of the related art, wherein FIG. 2a shows a discovery process, FIG. 2b shows a description process, FIG. 2c shows a control process, and FIG. 2d shows an event process;

FIG. 3 is a diagram schematically showing a configuration in which apparatuses for connecting separate networks are connected to one another according to the present invention;

FIG. 4 is a diagram showing an inner structure of the apparatus for connecting separate networks according to the present invention;

FIG. 5 is a diagram showing an inner structure of a join module in the apparatus for connecting separate networks according to the present invention;

FIGS. 6a to 6c are diagrams illustrating the inner operations of the join module in the apparatus for connecting separate networks according to the present invention; and

FIGS. 7a and 7b are flowcharts schematically illustrating a method for connecting separate networks according to the present invention.

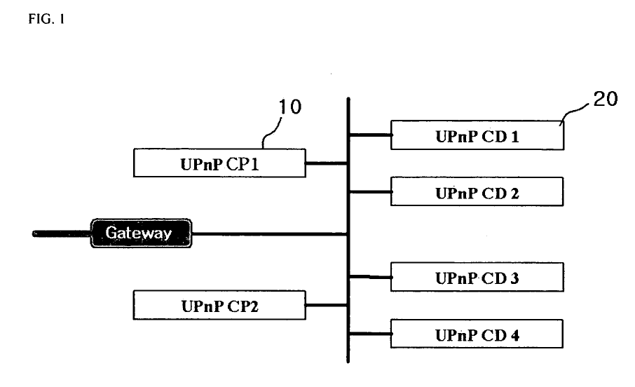

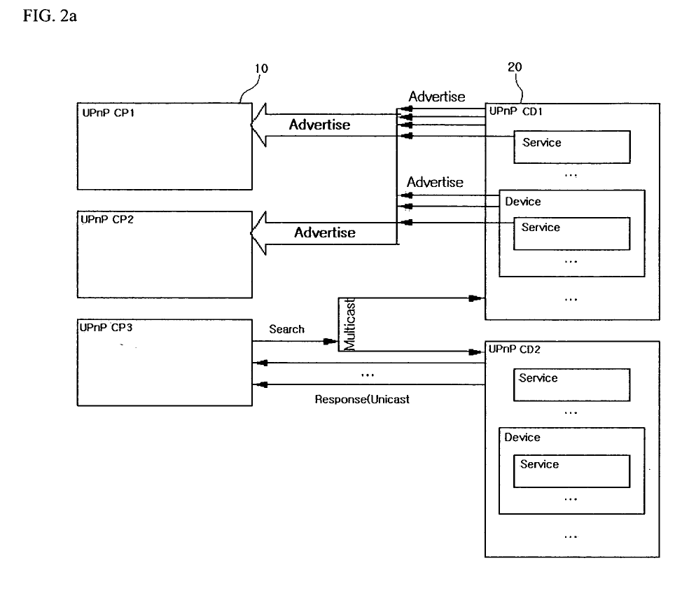

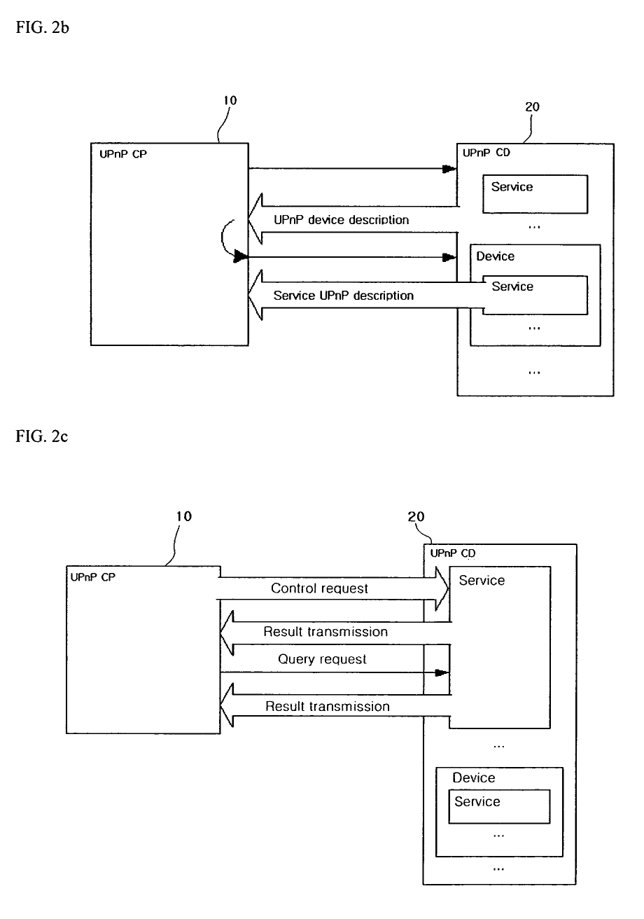

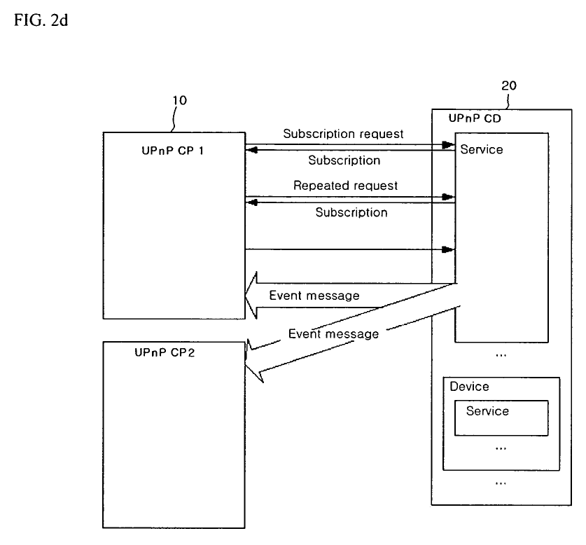

### DETAILED DESCRIPTION OF THE INVENTION

An exemplary embodiment of the present invention will be described in detail with reference to the accompanying drawings.

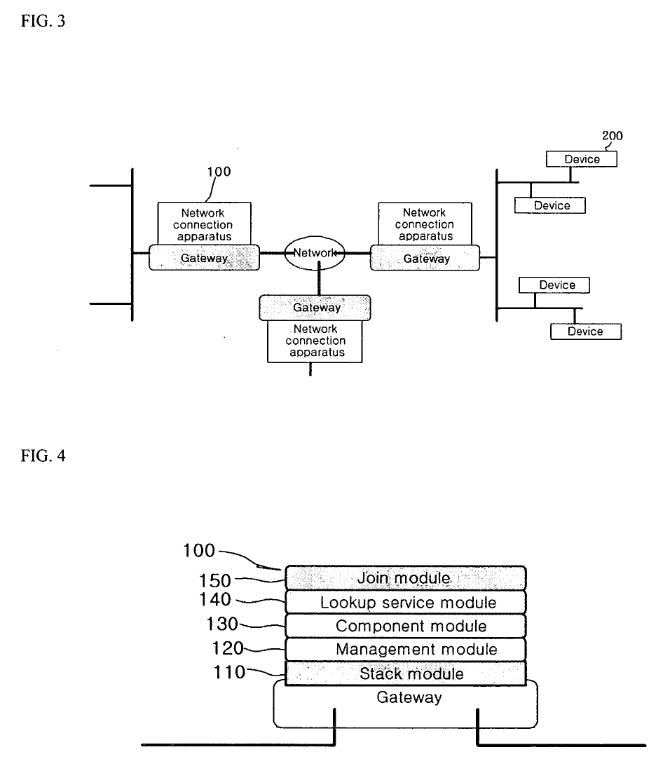

FIG. 3 is a diagram schematically showing a configuration in which apparatuses for connecting separate networks are connected to one another according to the present invention, wherein each of the network connection apparatuses 100 is provided within a gateway for connecting a relevant network to the outside. That is, separate networks are connected to one another through the network connection apparatuses 100, and thus, devices 200 that are not present in the same network can be mutually controlled.

FIG. 4 is a diagram showing an inner structure of the apparatus for connecting separate networks according to the present invention. The network connection apparatus 100 comprises a stack module 110, a management module 120, a component module 130, a lookup service module 140, and a join module 150.

The network connection apparatus 100 manages information about the devices 200 present in a network and mutually connects the devices 200 present in each of the separate networks to one another, so that the other desired devices can be controlled even though they are not present in the same network.

The management module 120 collects and manages information about each of the devices 200 by performing a discovery process for the devices 200 present in a network. That is, the management module 120 transmits search messages to the devices 200 present in the network, searches for the devices 200 present in the network by receiving response messages from the devices 200, and requests descriptions of the searched devices to obtain information about the devices. Further, the management module 120 periodically checks the devices 200 present in the network.

The component module 130 generates a component representing services of the devices 200 present in the network on the basis of the information of the devices 200 collected by the management module 120. Here, the component includes commands and operations for the devices 200 present in the network, and service responses for the operations.

The lookup service module 140 allows information in the component generated by the component module 130 to be stored in a lookup table, and searches the component information about a specific device upon request for service of the specific device. Here, since the component information is stored in the form of the lookup table, the lookup service module 140 can easily search the component information about the relevant device.

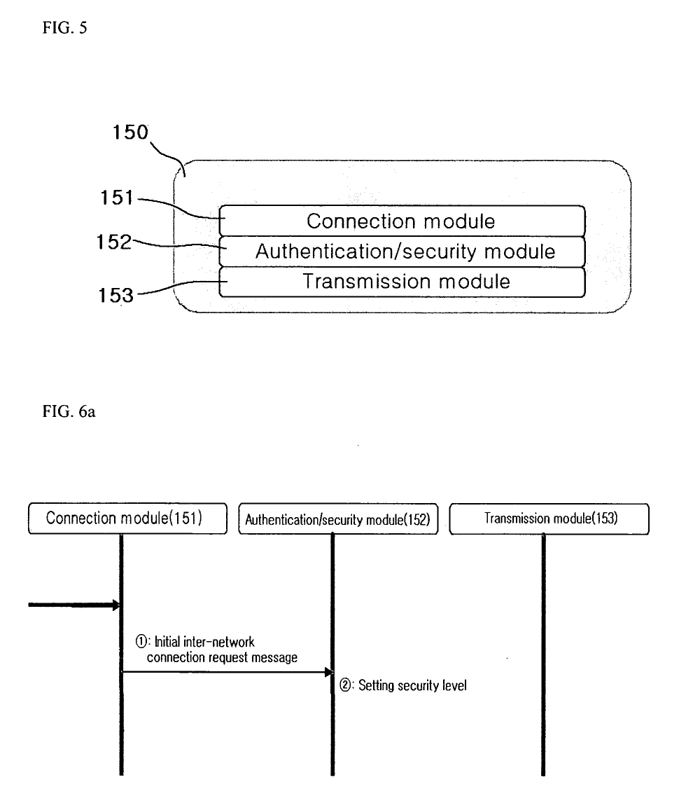

The join module 150 receives an inter-network connection request message transmitted from a first network and connects the first network to a network to which the join module belongs, sets a security level for the connected first network, and controls a network command message according to the set level. The join module will be described in more detail with reference to FIG. 5.

The stack module 110 transmits a control message to the devices 200 present in the network.

FIG. 5 is a diagram showing an inner structure of the join module in the apparatus for connecting separate networks according to the present invention. The join module 150 comprises a connection module 151, an authentication/security module 152, and a transmission module 153.

The connection module 151 receives the inter-network connection request message transmitted from the first network, and connects the two networks to each other. Here, the connection module 151 contains connection information (e.g., public IP address and port number) about the first network that has transmitted the inter-network connection request message and the devices present in the first network. That is, the connection module 151 manages the public IP address of a device 200 that has requested a connection or the public IP address of a gateway of a network to which the device 200 belongs, so that the connection module 151 can transmit a message through the public IP address of the relevant device 200 or the public IP address of the gateway of the network to which the device 200 belongs. Here, it can be understood that the type of message transmitted to the public IP address is a Hyper Text Transfer Protocol (HTTP) Post format.

Further, the connection module 151 checks periodically whether the first network that has transmitted the inter-network connection request message transmits a network command message every predetermined period of time. If a network command message is not received from the first network within the predetermine period of time, the connection module 151 terminates the connection of devices connected to each other. Furthermore, in order to terminate the connection, the first network that has transmitted the inter-network connection request message transmits a message for informing the termination thereof to a second network so as to cause the relevant device to be removed from the connection list of the second network and then also removes the relevant device from the connection list of the first network.

The authentication/security module 152 determines whether to allow the connection for the first network that has transmitted the inter-network connection request message to the connection module 151, and sets and checks a security level thereof. Further, the authentication/security module 152 stores and keeps information on the connection allowance for the first network that has transmitted the inter-network connection request message and on the security level thereof. Here, whether to allow the connection of the first network is performed as follows: after confirming the connection information about the first network that has transmitted an inter-network connection request message, the connection is rejected if it is confirmed that the first network is an unwanted network whereas the connection is allowed only if it is confirmed that the first network is a wanted network. In addition, the security level is applied differently depending on the first network that has transmitted the inter-network connection request message. That is, the security levels are first set to the respective devices present in a network to which the authentication/security module 151 belongs. Then, when the first network that has transmitted the inter-network connection request message is connected, it is determined on the basis of the set security levels, which device will be connected to the first network. Therefore, a high security level is set to an important device, so that only devices whose security levels are set at lower levels are shown when connected to the first network.

The transmission module 153 transmits a network command message requested by the first network for which connection is allowed by the authentication/security module 152. Here, the network command message means all messages transmitted and received between the first and second networks. For example, a discovery message, a notify message, a control message, a device information request message and the like may be included in the network message. Further, the transmission module 153 transmits information about a specific device stored in a lookup table of the cooperating lookup service module 140 at the request of the first network.

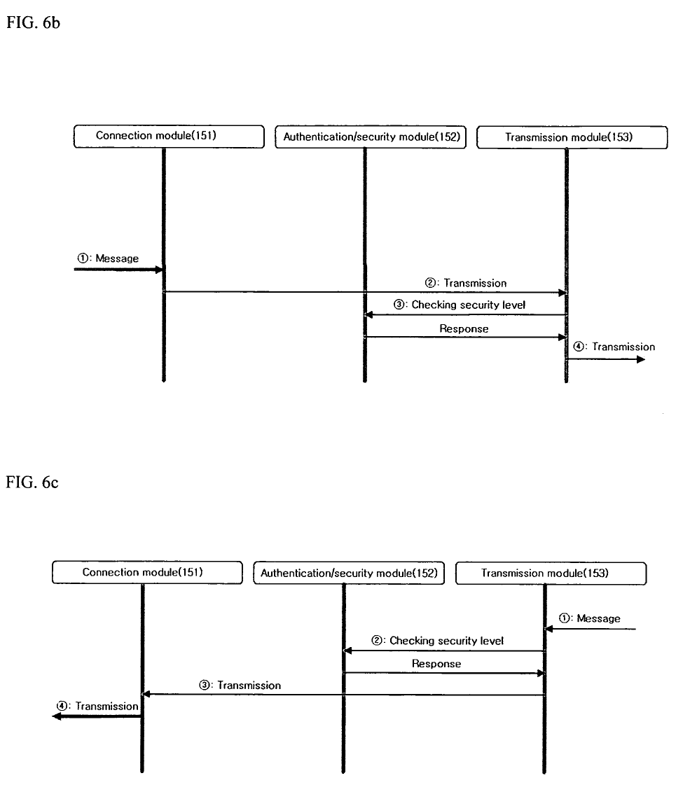

FIGS. 6a to 6c are diagrams illustrating the inner operations of the join module of the apparatus for connecting separate networks according to the present invention.

FIG. 6a is a diagram illustrating a process of setting security levels accordingly when the first network transmits the initial inter-network connection request message to the second network. First, when the first network transmits the initial inter-network connection request message to the second network, the connection module 151 transmits the received initial inter-network connection request message to the authentication/security module 152.

Then, the authentication/security module 152 analyzes the received initial inter-network connection request message, and sets and stores the security level for the first network accordingly. Here, the security level is applied differently depending on the first network connected to the second network.

FIG. 6b is a diagram showing a case where the second network receives a network command message from the first network. When a network command message is transmitted from the first network, the connection module 151 receives the network command message and transmits the received network command message to the transmission module 153. Then, the transmission module 153 causes the authentication/security module 152 to search a security level for the network command message received from the first network, and transmits both the searched security level and the network command message to the second network.

FIG. 6c is a diagram showing a case where the second network transmits a response message in response to a network command message requested by the first network. First, when the second network sends a response message to be transmitted to the first network through the transmission module 153, the authentication/security module 152 checks a security level of the response message and determines whether the response message can be transmitted. If it is determined that the response message can be transmitted, the transmission module 153 transmits the response message to the connection module 151, which in turn transmits the response message to the first network.

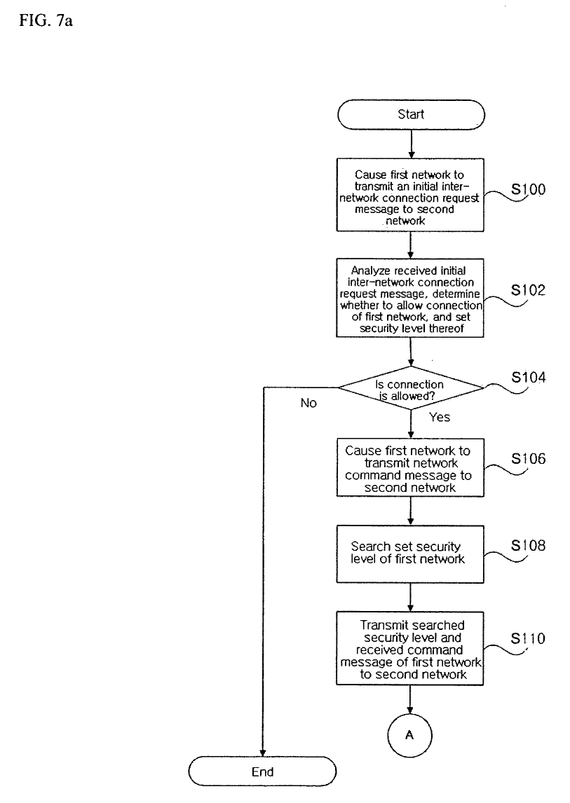

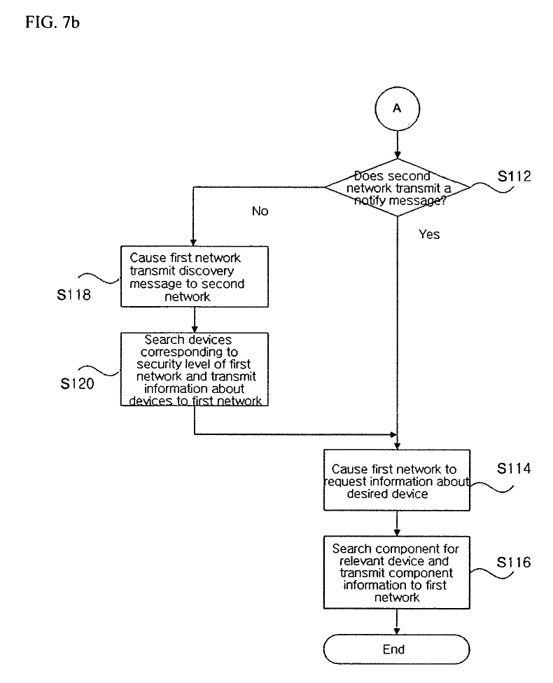

FIGS. 7a and 7b are flowcharts schematically illustrating a method for connecting separate networks according to the present invention. First, when the first network transmits an initial inter-network connection request message to the second network (S100), the connection module 151 of the second network transmits the received initial inter-network connection request message to the transmission module 153. Here, the initial inter-network connection request message includes information about the first network.

Then, the transmission module 153 transmits the received initial inter-network connection request message to the authentication/security module 152 so as to determine whether to allow the connection of the first network and to set a security level thereof (S102). Here, the security level is set differently depending on the connected first network, and the set security level is stored in the authentication/security module 152 according to the networks.

Thereafter, if the connection is allowed for the first network, the first network transmits a network command message to the second network and the authentication/security module 152 of the second network searches for the set security level of the first network (S104 to S108).

And then, the transmission module 153 transmits the searched security level and network command message of the first network to the second network (S110). At this time, if the second network transmits a response message for the network command message received from the first network, the authentication/security module 152 checks the security level for the response message to be transmitted and determines whether the response message suitable for the security level is transmitted. Here, the reason that the response message is suitable for the security level is to confirm whether information about a device whose security level is higher than the set security level, which should not be transmitted to the first network, is transmitted.

When the security level and network command message of the first network are transmitted to the second network, the second network transmits a notify message to the first network so as to inform the first network what devices are connected to the second network (S112). At this time, the second network selects only the devices corresponding to the security level of the first network and transmits information on the selected devices to the first network.

In the meantime, in a case where the network command message transmitted from the first network is a search message for looking for a specific device within the second network, the second network searches the devices corresponding to the searched security level of the first network and transmits information on the searched devices to the first network (S118, S120). Further, in a case where the network command message transmitted from the first network is a message for requesting information about a specific device within the second network, the second network searches a component of the specific device stored in the lookup service module 140 and transmits information on the searched component to the first network.

Then, when the first network requests the second network for device information about a desired device, the second network searches a component for the relevant device and transmits information on the searched component to the first network (S114, S116). Therefore, the first network can control the device connected to the second network. That is, even though the devices present in the first and second networks are not present in the same network, each of the first and second networks can control a desired device present in the other network.

In the meantime, when the first network sends the second network a connection termination request message for a currently connected device thereof, the second network deletes the relevant device of the first network currently connected to the second network from a connection list and the first network also deletes the relevant device of the second network currently connected to the first network from a connection list. Furthermore, if a network command message is not received from the first network for a predetermined period of time, the second network automatically terminates a connection with the first network.

An example of the present invention will be now explained. One's friend wishes to hear at his/her home a song stored in a compact disk (CD) player located in one's home. Here, the CD player is a UPnP device having a UPnP AV MediaServer function and is registered in the network connection apparatus 100 in the gateway connected to the outside.

First, one informs the friend of the public IP address of one's gateway and the number of a port connected to the network connection apparatus 100 so that he/she can transmit an inter-network connection request to one's network. Here, if one's gateway has its own web server, the friend can request the connection with one's network by receiving one's web address, accessing one's web page, and clicking the connection request button.

Then, when the friend transmits the inter-network connection request message to one's network, the inter-network connection request message is delivered through the connection module 151 and is shown through a monitor connected to the gateway or the network connection apparatus 100.

It is confirmed whether the friend has sent the transmitted inter-network connection request message. Then, the connection of the friend's network is allowed and the security level of the friend's network is set. For example, if the security level of the friend's network is set to “2”, the friend can access only those devices corresponding to security level “2” or lower among all the devices present in one's network when connecting with one's network. That is, the current security level of the CD player is set to “2” and the devices whose levels are set to “2” or “1” are accessible to the friend. If there are any devices intended not to be accessible to the friend, their security levels should be set to be greater than “2”. Thus, these devices cannot be connected to the friend's network. In the meantime, information about the devices whose connection with the friend's network is allowed and whose security level is set to “2” is stored in the authentication/security module 152.

After the friend is connected, the transmission module 153 transmits a notify message for the devices whose security levels are equal to or less than “2” to the friend's network through the connection module 151.

Then, the friend's network analyzes the received notify message and requests desired device information (service information about the CD player in this case). Thus, the friend can search for the CD player located in the living room of one's home and can hear a desired piece of music through a CD player having an UPnP MediaRenderer function located in his/her home.

In the meantime, when the friend requests a connection termination after hearing the predetermined CD, a connection termination request message is transmitted to one's network through the connection module 151. At this time, one can ask the friend whether he/she has finished hearing the CD so as to perform the connection termination. That is, if a connection termination is requested, the connection module 151 transmits a termination request message to the transmission module 153 and deletes connection information of a relevant device from the connection list of one's network. Further, the authentication/security module 152 is requested to delete the information about the relevant device or to no longer manage the information. The transmission module 153 prevents messages of the network from being transmitted outside through the connection module 151.

According to the present invention so constructed, there is an advantage in that mutual connection and control between devices present in separate networks can be made by connecting the separate networks with one another.

Further, there is another advantage in that connection with an unwanted network can be avoided, since a user can freely determine whether to allow a requesting network for the connection and set a security level thereof.

Although the present invention has been described in connection with the exemplary embodiments thereof, it will be apparent to those skilled in the art that various changes and modifications can be made thereto without departing from the scope and spirit of the present invention defined by the appended claims. Therefore, simple changes of the embodiments of the present invention will fall within the scope of the invention.

What is claimed is:

1. A network connection apparatus, comprising:
a join module for connecting a second network, to which the join module belongs, with a first network in response to an inter-network connection request message transmitted from the first network, setting a security level of the first network to a set security level, and controlling network command messages in response to the set security level.

2. The apparatus as claimed in claim 1, wherein the join module comprises:
a connection module for receiving the inter-network connection request message transmitted from the first network and connecting the first network with the second network;
an authentication/security module for determining whether to allow a connection of the first network that has transmitted the inter-network connection request message to the connection module, and setting and checking the security level of the first network; and
a transmission module for transmitting a requested network command message requested by the first network when the connection is allowed by the authentication/security module.

3. The apparatus as claimed in claim 1, further comprising:
a management module for collecting and managing information about devices present in the second network by performing a discovery process for the devices; and
a component module for generating a component representing services of the devices present in the second network on a basis of the information about the devices collected by the management module.

4. The apparatus as claimed in claim 3, further comprising:
a stack module for transmitting a control message to the devices present in the second network; and
a lookup service module for storing information about the component generated by the component module in a lookup table, and searching for component information of a specific device upon a request for a service of the specific device.

5. The apparatus as claimed in claim 2, wherein the connection module contains connection information about the first network or the devices present in the first network.

6. The apparatus as claimed in claim 2, wherein the connection module checks periodically whether the first network transmits a transmitted network command message every predetermined period of time, and terminates the connection if the transmitted network command message is not received within the predetermined period of time.

7. The apparatus as claimed in claim 2, wherein the security level is applied differently depending on the first network to be connected.

8. The apparatus as claimed in claim 2, wherein the transmission module transmits the network command messages transmitted and received between the first network and the second network to which the join module belongs.

9. A method for connecting separate networks, comprising:
(a) transmitting an initial inter-network connection request message to a second network by a first network;
(b) analyzing the initial inter-network connection request message and setting a security level of the first network to a set security level by the second network;
(c) transmitting a network command message to the second network by the first network;
(d) searching, by the second network, the set security level of the first network which has transmitted the network command message to generate a searched security level; and
(e) transmitting the searched security level and the network command message to the second network.

10. The method as claimed in claim 9, wherein the initial inter-network connection request message includes information about the first network that has transmitted the initial inter-network connection request message.

11. The method as claimed in claim 9, wherein the security level is applied differently depending on the first network to be connected.

12. The method as claimed in claim 9, wherein (b) comprises analyzing the initial inter-network connection request message and determining whether to allow a connection between the first and the second networks.

13. The method as claimed in claim 9, wherein (e) comprises transmitting a notify message to the first network.

14. The method as claimed in claim 9, further comprising:
transmitting a response message for the network command message by the second network; and
checking a security level for the response message of the second network.

15. The method as claimed in claim 9, further comprising, if the network command message is a search message for looking for a device present in the second network, searching for devices corresponding to the searched security level of the first network and transmitting information about the devices.

16. The method as claimed in claim 9, further comprising, if the network command message is a message for requesting information about a specific device present in the second network, searching component information about the specific device among component information about the devices present in the second network and transmitting the component information about the specific device.

17. The method according to claim 9, further comprising, if the network command message is not received from the first network within a predetermined period of time, terminating a connection between the first and the second networks.

18. A method for connecting separate networks, comprising:
(a) receiving an initial inter-network connection request message from an external network;
(b) analyzing the initial inter-network connection request message and setting a security level of the external network to a set security level;
(c) receiving a network command message from the external network;
(d) searching the set security level of the external network which has transmitted the network command message to generate a searched security level; and
(e) transmitting the searched security level and the network command message to another network to which the external network is connected.

19. The method as claimed in claim 18, wherein the initial inter-network connection request message includes information about the external network that has transmitted the initial inter-network connection request message.

20. The method as claimed in claim 18, wherein the security level is applied differently depending on the external network to be connected.

21. The method as claimed in claim 18, wherein (b) comprises analyzing the initial inter-network connection request message and determining whether to allow a connection between the external and the another networks.

22. The method as claimed in claim 18, wherein (e) comprises transmitting a notify message to the another network.

23. The method as claimed in claim 18, further comprising:
transmitting a response message for the network command message to the external network; and
checking a security level for the response message.

24. The method as claimed in claim 18, comprising, if the network command message is a search message for a device present in the another network, searching for devices corresponding to the searched security level of the external network and transmitting information about the devices.

25. The method as claimed in claim 18, further comprising, if the network command message is a message for requesting information about a specific device present in the another network, searching for component information about the specific device and transmitting the component information about the specific device.

26. The method as claimed in claim 18, further comprising, if the network command message is not received from the external network within a predetermined period of time, terminating a connection between the external and the another networks.
